(19) United States
(12) Patent Application Publication
(10) Pub. No.: US 2019/0001614 A1
(43) Pub. Date: Jan. 3, 2019

(54) WOOL TEXTILE STRUCTURE

(71) Applicant: CHIA HER INDUSTRIAL CO,, LTD, Tainan City (TW)

(72) Inventor: Pei-Ju Liu, Taipei City (TW)

(73) Assignee: CHIA HER INDUSTRIAL CO,, LTD, Tainan City (TW)

(21) Appl. No.: 16/022,728

(22) Filed: Jun. 29, 2018

Related U.S. Application Data
(60) Provisional application No. 62/527,020, filed on Jun. 29, 2017.

(51) Int. Cl. B32B 5/02; D03D 15/08; D04B 1/14; D04B 21/20; B32B 27/12; B32B 27/40; D04B 1/24

(52) U.S. Cl. CPC B32B 5/026; B32B 2250/03; D04B 1/14; D04B 21/207; B32B 5/024; B32B 27/12; B32B 27/40; D04B 1/24; D10B 2331/02; D10B 2331/10; D10B 2201/02; D10B 2211/02; D10B 2401/022; D10B 2501/04; B32B 2437/00; B32B 2262/08; B32B 2262/0292; B32B 2262/0207; B32B 2262/0261; B32B 2262/062; B32B 2307/7265; B32B 2307/51; D03D 15/08

(57) ABSTRACT

A wool textile structure is provided, including a surface layer, a middle layer, and an inner layer. The surface layer is composed of a woven fabric. The middle layer is composed of a hydrophilic film. The inner layer is composed of a wool knitted fabric, which contacts a wearer's skin.

### CROSS-REFERENCE TO RELATED APPLICATION

This application claims the priority benefit of U.S. provisional application serial no. 62/527,020, filed on Jun. 29, 2017. The entirety of the above-mentioned patent application is hereby incorporated by reference herein and made a part of this specification.

### BACKGROUND

### Technical Field

The invention is related to a wool textile structure, and more particularly, to a wool textile structure which improves wearing comfort and provides waterproof and moisture permeability function.

### Description of Related Art

Conventional waterproof and moisture permeability textile is usually composed of a two-layer or three-layer fabric structure. The first layer is mostly a woven fabric composed of polyamide or polyester fibers. The second layer is mostly composed of microporous polyurethane or PTFE films. If there is a third layer, it is mostly a woven fabric or knitted fabric composed of polyamide or polyester fibers. Generally, the skin contacting layer of the conventional waterproof and moisture permeability textile is the polyamide fabric, the polyester fabric or the microporous film, which causes several disadvantages. If the wearer's skin contacts the microporous film when the wearer sweats during exercise, the wet and sticky feeling increases, so the wearing comfort is reduced. On the other hand, the wearer is unable to stay warm in the low temperature environment due to the polyamide or polyester fabric or microporous film.

Based on the above, a textile structure capable of improving wearing comfort and providing waterproof and moisture permeability function is urgently needed.

### SUMMARY

The invention provides a wool textile structure, wherein the skin contacting layer is the wool knitted fabric. Therefore, the wearer is able to stay warm due to the wool fiber. Besides, the cuticle of the wool fiber opens and closes with the humidity, so the humidity of the contacting interface between the textile and the skin can be adjusted to improve wearing comfort.

The invention provides a wool textile structure including a surface layer, a middle layer, and an inner layer. The surface layer is composed of a woven fabric. The middle layer is composed of a hydrophilic film. The inner layer is composed of a wool knitted fabric, which contacts a wearer's skin.

In an embodiment of the invention, a material of the hydrophilic film includes polyurethane.

In an embodiment of the invention, the woven fabric is composed of polyamide fibers, elastic fibers and cotton fibers.

In an embodiment of the invention, the elastic fibers include polyurethane fibers or rubber fibers.

In an embodiment of the invention, the woven fabric is formed by weaving warp yarns and weft yarns, the warp yarns are composed of the polyamide fibers and the elastic fibers, and the weft yarns are composed of the cotton fibers and the elastic fibers.

In an embodiment of the invention, the warp yarn are composed of 76% to 96% of the polyamide fibers and 4% to 24% of the elastic fibers, the weft yarns are composed of 84% to 98% of the cotton fibers and 2% to 16% of the elastic fibers.

Based on the above, the invention provides a wool textile structure including an inner layer composed of a wool knitted fabric, which contacts a wearer's skin. Therefore, the wearer is able to stay warm in the low temperature environment due to the wool fiber.

Besides, the cuticle of the wool fiber opens and closes with the humidity, so the humidity of the contacting interface between the textile and the skin can be adjusted to improve wearing comfort and prevent wet and sticky feeling when the wearer sweats during exercise. On the other hand, the wool textile structure of the invention also includes a surface layer composed of a woven fabric with wear resistance and a middle layer composed of a hydrophilic film with waterproof and moisture permeability function.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a cross-sectional schematic view of a wool textile structure according to the embodiment of the invention.

### DESCRIPTION OF THE EMBODIMENTS

Reference will now be made in detail to the present preferred embodiments of the invention, examples of which are illustrated in the accompanying drawings. In order to clearly illustrate the invention, the sizes and the ratios of the layers may be exaggerated in the figures of the specification.

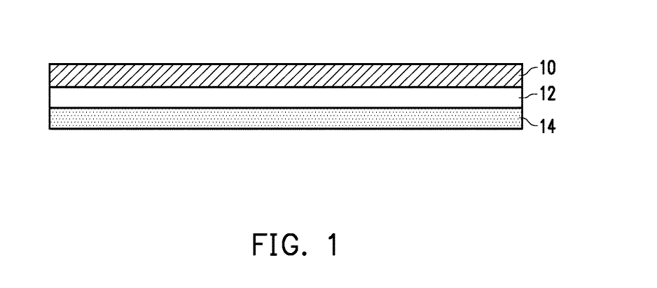

FIG. 1 is a cross-sectional schematic view of a wool textile structure according to the embodiment of the invention.

Referring to FIG. 1, the wool textile structure includes a surface layer 10, a middle layer 12, and an inner layer 14. Hereinafter, the surface layer 10, the middle layer 12, and the inner layer 14 of the wool textile structure are described in detail.

In the present embodiment, the surface layer 10 is composed of a woven fabric with wear resistance, and the woven fabric can be composed of polyamide fibers, elastic fibers and cotton fibers. The elastic fibers may include polyurethane fibers or rubber fibers, but the invention is not limited thereto. More particularly, the woven fabric can be formed by weaving warp yarns and weft yarns, wherein the warp yarns can be composed of 76% to 96% of the polyamide fibers and 4% to 24% of the elastic fibers, and the weft yarns can be composed of 84% to 98% of the cotton fibers and 2% to 16% of the elastic fibers, but the invention is not limited thereto.

In the present embodiment, the middle layer 12 is composed of a hydrophilic film, so as to provide waterproof and moisture permeability function. The material of the middle layer 12 may include polyurethane, but the invention is not limited thereto.

In the present embodiment, the inner layer 14 is composed of a wool knitted fabric, which contacts a wearer's skin. Therefore, the inner layer 14 is able to adjust the temperature and humidity of the contacting interface between the textile and the skin, so the wearer is able to stay warm in the low temperature environment, the wearing comfort is improved and the wet and sticky feeling during exercise is prevented.

Based on the above, the invention provides a wool textile structure including an inner layer composed of a wool knitted fabric, which contacts a wearer's skin. Different from the conventional waterproof and moisture permeability textile which contacts the wear's skin by polyamide fabric, the polyester fabric or the microporous film, the skin contacting layer of the invention is the wool knitted fabric. Therefore, the wearer is able to stay warm in the low temperature environment due to the wool fiber. Besides, the cuticle of the wool fiber opens and closes with the humidity, so the humidity of the contacting interface between the textile and the skin can be adjusted to improve wearing comfort and prevent wet and sticky feeling during exercise. On the other hand, the wool textile structure of the invention also includes a surface layer composed of a woven fabric with wear resistance and a middle layer composed of a hydrophilic film with waterproof and moisture permeability function.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A wool textile structure, comprising:
a surface layer composed of a woven fabric;
a middle layer composed of a hydrophilic film; and
an inner layer composed of a wool knitted fabric, which contacts a wearer's skin.

2. The wool textile structure of claim 1, wherein a material of the hydrophilic film includes polyurethane.

3. The wool textile structure of claim 1, wherein the woven fabric is composed of polyamide fibers, elastic fibers and cotton fibers.

4. The wool textile structure of claim 3, wherein the elastic fibers include polyurethane fibers or rubber fibers.

5. The wool textile structure of claim 3, wherein the woven fabric is formed by weaving warp yams and weft yams, the warp yams are composed of the polyamide fibers and the elastic fibers, and the weft yams are composed of the cotton fibers and the elastic fibers.

6. The wool textile structure of claim 5, wherein the warp yam are composed of 76% to 96% of the polyamide fibers and 4% to 24% of the elastic fibers, the weft yams are composed of 84% to 98% of the cotton fibers and 2% to 16% of the elastic fibers.
